(19) United States
(12) Patent Application Publication
(10) Pub. No.: US 2017/0265403 A1
(43) Pub. Date: Sep. 21, 2017

(54) Control Methods and Apparatus for an Irrigation System Which Employs Pressure Pulse-Based Communications

(71) Applicant: Rainboxx, Inc., Austin, TX (US)

(72) Inventor: Alex Khabbaz, Austin, TX (US)

(73) Assignee: Rainboxx, Inc., Austin, TX (US)

(21) Appl. No.: 15/074,158

(22) Filed: Mar. 18, 2016

(51) Int. Cl. A01G 25/16; G05B 15/02

(52) U.S. Cl. CPC A01G 25/16; A01G 25/165; G05B 15/02

(57) ABSTRACT

A control unit includes a communication output terminal associated with a communication signal circuit, and a supply output terminal associated with a supply signal circuit. The communication signal circuit operates to apply a communication drive signal to the communication output terminal in response to a communication control signal, while the supply signal circuit operates to apply a supply operating signal to the supply output terminal in response to a supply control signal. The control unit further includes a controller which operates to direct the supply control signal to the supply control circuit with a particular timing relative to directing the communication control signal to the communication signal circuit. More specifically, the controller directs the supply control signal to the supply signal circuit at a first point in time and then directs the communication control signal to the communication signal circuit after a communication condition is met in an irrigation system.

### TECHNICAL FIELD OF THE INVENTION

The present invention relates to irrigation systems in which various irrigation zones are controlled through pressure pulse signals communicated through the irrigation water in the conduits of the irrigation system. More particularly, the invention includes methods and apparatus for facilitating the desired pressure pulse-based communications in the system.

### BACKGROUND OF THE INVENTION

Modern irrigation systems, particularly those used in residential settings, commonly include a network of distribution conduits including a number of separately controlled irrigation zones. The network of distribution conduits is connected to a supply conduit that supplies irrigation under suitable pressure, and a master valve is used to control the water supply from the supply conduit. Each irrigation zone includes a zone valve which is opened to allow irrigation in the respective zone, and then closed while another irrigation zone is operating. An irrigation controller is typically included in the irrigation system to open and close both the master valve and zone valves as needed according to an irrigation schedule. In particular, the irrigation controller controls the master valve to open simultaneously with a first zone valve in a sequence of zone valves to be operated for a given irrigation program, and then closes the master valve at the end of the sequence.

In order to control the master valve and zone valves, the irrigation controller must be able to send to the respective valve a signal which either operates the valve or triggers another signal to operate the valve. Perhaps the most common arrangement currently used for residential irrigation systems is an arrangement in which the irrigation controller sends operating signals to the master valve and each zone valve through a respective electrical wire which runs from a terminal of the irrigation controller to the respective valve. The operating signals are at a suitable voltage to operate the respective zone or master valve, which is commonly a solenoid-operated valve.

The electrical wires which run to the various remote valves in this common arrangement represent a weak link in the system for a number of reasons. First there is the added cost of the electrical wires and the cost of installing the wires. Additionally, the wires are subject to damage during yard work. The wires and connections to the wires are also subject to corrosion since they are exposed to a relatively harsh outdoor and underground environment.

In order to address some of the problems with having to run electrical wires in an irrigation system, irrigation systems have been proposed which eliminate the need for such wires. In particular, U.S. Pat. No. 7,383,721 discloses an irrigation system in which the remote zone valves are controlled through communications encoded in pressure pulses applied to the irrigation water in the network of irrigation conduits. The pressure pulses in this proposed system are detected and interpreted by a signal receiving arrangement associated with the remote valve, and the receiving arrangement then produces a suitable operating signal to open or close the valve accordingly. Although this pressure pulse communication arrangement for controlling the zone valves in an irrigation system eliminates the need for electrical wires to the zone valves, the arrangement raises a number of other issues which have ultimately prevented the wide-spread adoption of such systems. The present invention is directed to some of those problems, especially the problem of ensuring reliable pressure pulse-encoded communications to the remote zone valves.

### SUMMARY OF THE INVENTION

The present invention provides a control unit that ensures the irrigation conduits in a pressure pulse communication-based irrigation system are ready for receiving the desired pressure pulse signals necessary for communicating control instructions for the remote zone valves. The invention also encompasses master/pulser devices incorporating such a control unit and further encompasses methods for operating an irrigation system relying on pressure pulse-based communications to the zone valves.

A control unit according to one aspect of the present invention includes a communication output terminal associated with a communication signal circuit, and a supply output terminal associated with a supply signal circuit. The communication signal circuit operates to apply a communication drive signal to the communication output terminal in response to a communication control signal, while the supply signal circuit operates to apply a supply operating signal to the supply output terminal in response to a supply control signal. The control unit according to this aspect of the invention further includes a controller such as a suitable microcontroller which operates to direct the supply control signal to the supply control circuit with a particular timing relative to directing the communication control signal to the communication signal circuit. More specifically, the controller directs the supply control signal to the supply signal circuit at a first point in time and then directs the communication control signal to the communication signal circuit after a communication condition is met in the network of irrigation conduits after the first point in time. The communication condition is selected to generally ensure that the supply valve is opened to the network of irrigation conduits for a sufficient period of time prior to a pressure-pulse communication attempt so that the conduits are full of irrigation water and in condition to transmit the desired pressure pulse-encoded information to the zone valves. Thus, for example, in the event irrigation water has leaked or otherwise drained from the network of irrigation conduits since a zone valve in the system was last operated, the control unit according to the invention causes the irrigation conduits to be refilled so that the desired pressure pulses may be communicated to the zone valves when desired.

Another aspect of the invention encompasses a master/pulser unit which incorporates the control unit as described above. Such a master/pluser unit may include in addition to the control unit, a flow path (defined by a suitable conduit) having a supply end adapted to receive irrigation water from a supply conduit and having a distribution end adapted to be connected to the network of irrigation conduits. An electrically operated supply valve is connected in the flow path, along with a branch conduit preferably connected between the supply valve and the distribution end. An electrically operated pulser valve is connected in the branch conduit in position to selectively open and close the branch conduit to the atmosphere. In this aspect of the invention, the supply terminal of the control unit is connected to the supply valve, and the communication output terminal is connected to the pulser valve. When the master/pulser unit is connected for operation with a network of irrigation conduits, the supply valve in the unit is responsible for controlling the supply of water to the system and the pulser valve is used to generate the pressure pulses for communications to the various zone valves and their associated receiving arrangement.

In the above description of the master/pulser unit, various elements are described as being “connected” to another element. For example, the preceding paragraph describes the master valve as being “connected” in the flow path. The term “connected” in this example and elsewhere in this disclosure and the accompanying claims means “operatively connected” so that the device may perform its stated function. Thus the supply valve is connected in the flow path so that the valve blocks flow through the flow path when the valve is closed, and allows flow through the flow path when the valve is open. As a further example, the above description that the supply terminal of the control unit is “connected” to the supply valve means that the terminal is connected via a suitable control wire to the electrically operated supply valve so that an electrical operating signal may be applied to a terminal of the supply valve to open and close the valve.

As noted above, the control unit sends the communication control signal to the communication signal circuit after a communication condition is met in the network of irrigation conduits. Any of a number of different conditions may be selected as the communication condition to ensure the irrigation conduits are in the desired condition for communicating pressure pulse-encoded signals. In one embodiment of a control unit according to the present invention, the communication condition comprises a predetermined amount of time after the first point in time. In this embodiment the control unit may employ a suitable timing arrangement to recognize when the predetermined amount of time has elapsed after the supply valve has been opened.

In other embodiments the communication condition may be identified by a measurable parameter of the network of irrigation conduits. The control unit in these embodiments may include a sensor input terminal connected to a sensor input of the controller. The controller in this case operates to determine whether the communication condition is met based on a sensor input signal received at the sensor input terminal. For example, the communication condition may comprise a predetermined flow rate and the sensor input signal is indicative of flow rate into the network of irrigation conduits. In this example the master/pulser unit may include a network condition sensor comprising a flow rate sensor. When the supply valve is opened by the control unit in these embodiments of the invention, the flow rate sensor will initially indicate a flow of irrigation water into the network of irrigation conduits in the event that irrigation water has drained from the conduits over a period of inactivity. Because all of the zone valves in the system are closed at this point, this initial flow will cease once the conduits leading to the zone valves fill with irrigation water. This cessation of flow into the network of irrigation conduits indicates the conduits are full and thus may be taken as an indication that the communication condition has been met.

Alternatively, the communication condition may comprise a predetermined pressure and the sensor input signal is indicative of pressure in the network of irrigation conduits. In this latter example, the master/pulser unit may include a network condition sensor comprising a pressure sensor connected at a suitable point to sense the pressure in the network of irrigation conduits. When the supply valve is opened by the control unit in this alternative embodiment, the pressure in the network of irrigation conduits will initially be below the supply line pressure assuming water has previously drained from the irrigation conduits. The pressure in the irrigation conduits will increase to the supply line pressure as the irrigation conduits fill with irrigation water from the supply line, and thus a pressure at or near the supply line pressure indicates the conduits are full and ready for pressure pulsed-based communications.

Another aspect of the invention includes a method for controlling an irrigation system which employs pressure pulse-based communications to zone valves. A method according to this aspect of the invention includes receiving a communication preparation signal which may be a signal generated at a suitable point in time before a zone of the irrigation system is to be activated. In response to the communication preparation signal, the method includes generating a supply control signal which is used to open the supply valve such as the supply valve described above in connection with the master/pulser unit. The method then includes determining if a communication-ready condition is present in the network of irrigation conduits, and in response to the communication-ready condition, applying a communication release signal to enable a communications to an electrically operated pulser valve in the irrigation system such as the above-described pulser valve.

These and other advantages and features of the invention will be apparent from the following description of illustrative embodiments, considered along with the accompanying drawings.

### BRIEF DESCRIPTION OF THE DRAWINGS

FIG. 1 is a block diagram showing an irrigation system incorporating a master/pulser unit according to one aspect of the present invention.

FIG. 2 is a block diagram of the master/pulser unit shown in FIG. 1.

FIG. 3 is a block diagram of a control unit according to an aspect of the invention.

FIG. 4 is a flow chart showing a method according to the invention.

### DESCRIPTION OF ILLUSTRATIVE EMBODIMENTS

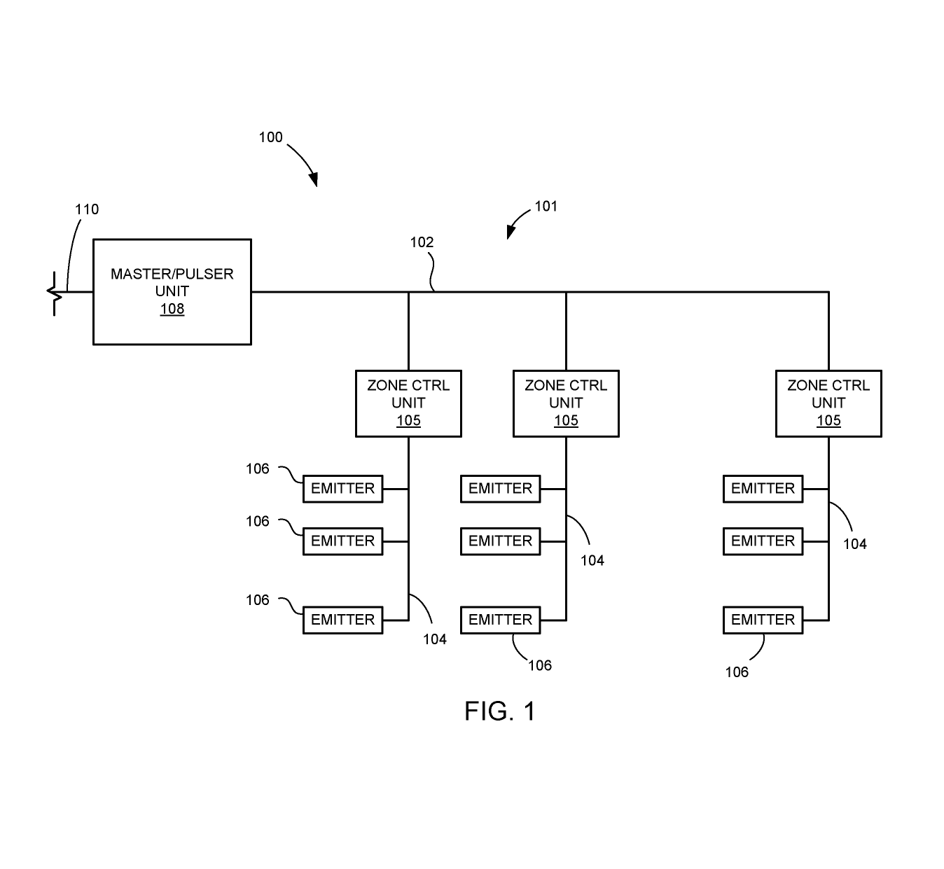

Referring to FIG. 1, an irrigation system 100 in which the present invention may be employed includes a network 101 of irrigation conduits including a main distribution conduit 102 and a number of zone distribution conduits 104. A zone control unit 105 is connected in each zone distribution conduit 104 and includes a zone valve (not shown separately) to control the flow of irrigation water to emitters 106 which are connected to the respective zone distribution conduit. The emitters 106 may include any suitable spray nozzle, bubbler or drip emitter, dripper line, or any other irrigation water emitter suitable for a given situation. Regardless of the particular type of emitters 106, the emitters associated with a given zone distribution conduit 104 are typically spaced apart appropriately and selected to apply a desired amount of irrigation water to a respective zone of the irrigation system over a time period that the zone is activated. Although FIG. 1 shows three zone distribution conduits 104, the present invention may, of course, be used with irrigation networks comprising any number of zone distribution conduits. A network of irrigation conduits may include more or fewer than three zone distribution conduits 104, however generally there will be at least two different zone distribution conduits in an irrigation system to control the irrigation of two different irrigation zones. Similarly, although the example of FIG. 1 shows three emitters 106 associated with each zone distribution conduit 104, more or fewer emitters may be controlled by a given zone control unit 105. Also, an irrigation system in which the invention may be employed is not limited to any particular application or setting. For example, irrigation system 100 may control irrigation for a residential landscape or garden, a commercial landscape or garden, or even conceivably a commercial farm.

FIG. 1 also shows that irrigation system 100 includes a master/pulser unit 108. Master/pulser unit 108 cooperates with the various zone control units 105 to control the flow of irrigation water in the system. In particular, master/pulser unit 108 functions generally to selectively allow the flow of irrigation water into the network 101 of irrigation conduits from a supply conduit 110, and also communicates with zone control units 105 through encoded pressure pulses introduced into the irrigation water within the network of irrigation conduits. As will be described in further detail below, the present invention helps ensure that the network 101 of irrigations conduits are filled with water and thus the network is ready for allowing the pressure pulse communications to zone control units 105.

It should be noted here that although the present invention is directed to apparatus and methods used with pressure pulse-based communications in irrigation systems, the various aspects of the invention are independent of the particular pressure pulse encoding used in the system. Thus, details of the pressure pulse generation, encoding, detection, and interpretation are not necessary for an understanding of the present invention. Such details are therefore omitted from this disclosure so as not to obscure the invention in unnecessary detail.

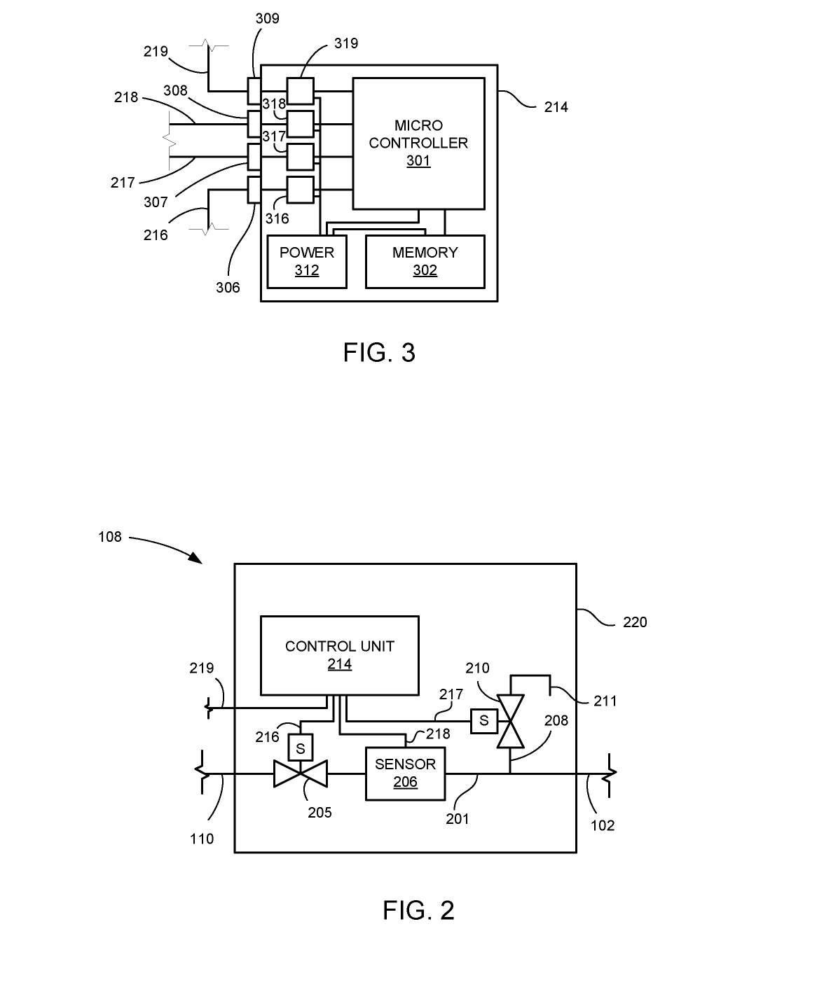

Referring to FIG. 2 master/pulser unit 108 defines a flow path 201 (which may simply be a length of suitable conduit) between supply conduit 110 at one end and main distribution conduit 102 at the opposite end. A supply control valve 205 is connected in the base conduit as is a sensor device 206. A branch conduit 208 is connected to flow path 201 and includes a pulser valve 210 operative to selectively open the branch conduit to atmosphere through the open distal end 211. The two valves 205 and 210 are preferably electrically operated valves such as suitable solenoid controlled valves, and are each connected by a suitable electrical line to a control unit 214 which controls the operation of the valves. Control unit 214 is also connected to receive signals from sensor 206. The example of FIG. 2 shows electrical control line 216 to supply control valve 205, electrical control line 217 to pulser valve 210, and electrical line 218 to sensor 206. These electrical lines may simply comprise suitable light gauge wires for carrying the signals described further below. Control unit 214 is also shown as being connected to an external input line 219, which may comprise a serial communications cable, or any other transmission path for transmitting instructions or other data to the control unit. Typically the various components of master/pulser unit 108 may be stored in a suitable housing such as a suitable irrigation valve box 220.

FIG. 3 shows a diagrammatically represented example of control unit 214 included in the master/pulser unit 108 illustrated in FIG. 2. This example control unit 214 includes a microcontroller 301 with external memory 302. Control unit 301 also includes an input/output arrangement including a communication output terminal 306, supply output terminal 307, a sensor input terminal 308, and an external input terminal 309. Referring to both FIGS. 2 and 3, communication output terminal 306 may be connected to electrical control line 217 extending from the control unit to pulser valve 210 while supply output terminal 307 may be connected to electrical control line 216 extending to supply valve 205. Sensor input terminal 308 may be connected to the electrical control line 218 extending to sensor 206, and external input terminal 309 may be connected to the external input line 219. Power for the input/output arrangement, microcontroller 301, and external memory 302 is provided through a suitable power supply 312 included in control unit 214. Power supply 312 may include a suitable battery for example. Power for operating the various components of control unit 214 may also come from an external source even though no external power connection is shown in FIG. 3. Even where external power is used, a battery may still be included to provide backup power should the external source fail.

In the illustrated example control unit shown in FIG. 3 each input or output terminal is connected to a suitable driver circuit that provides an interface to microcontroller 301. Communication output terminal 306 is connected to a communication signal circuit 316, while supply output terminal 307 is connected to a supply signal circuit 317. These driver circuits for the output terminals may be any suitable circuit for receiving a control signal from microcontroller 301 and, in response to the control signal, applying a suitable signal to the respective terminal to control the connected valve. For example these driver circuits may include a suitable transistor which applies a signal at a suitable voltage to the respective output terminal in response to a control signal from microcontroller 301. Each input terminal is also shown connected to a suitable driver circuit, with sensor input terminal 308 connected to a sensor driver circuit 318 and external input terminal 309 connected to an external input driver circuit 319. These driver circuits for the input terminals may be a suitable circuit adapted to receive an analog or digital input signal from the respective input terminal and, in response to that received signal, apply a suitable digital signal to one or more pins of microcontroller 301.

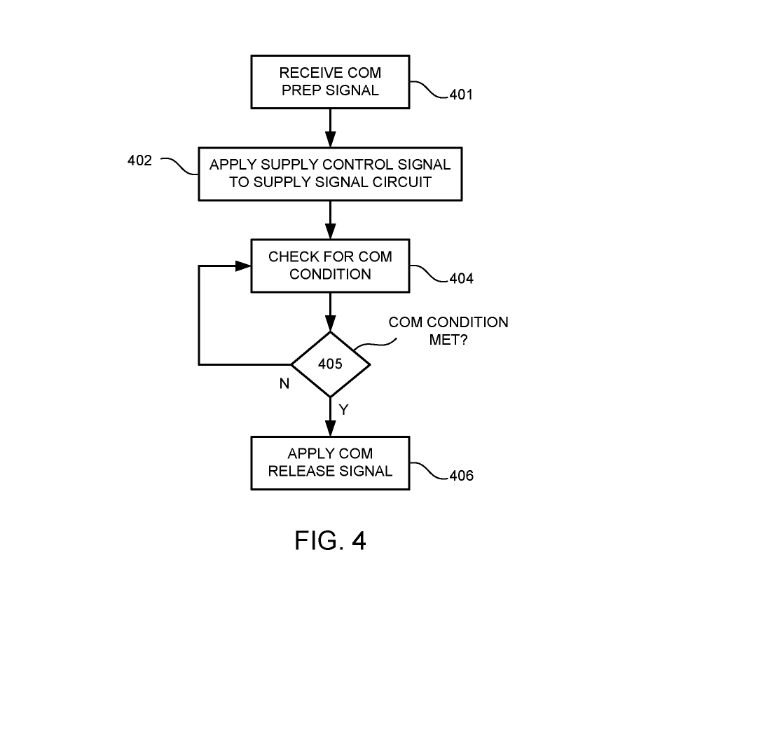

Microcontroller 301 may comprise any controller suitable for performing the process described more fully below with reference to FIG. 4. In a typical installation, microcontroller 301 will also be responsible for executing an irrigation program in which the different irrigation zones are activated according to some schedule. Also, since the irrigation system 100 relies on pressure pulse-based communications to control the various zone control units 105, microcontroller 301 will be programmed to direct pulser valve 210 to generate pressure pulses encoded according to a suitable encoding scheme. As noted above, the specifics of this pressure pulse communication, including the encoding scheme are not necessary for an understanding of the present invention and are thus omitted here. Similarly, the details of any irrigation program executed by microcontroller 301 are also unnecessary for an understanding of the present invention and such details are also omitted.

The operation of control unit 214 may now be described with reference to the flow chart of FIG. 4. It will be appreciated that the hardware references in the following discussion are references to hardware elements shown in FIGS. 1-3.

FIG. 4 shows first receiving a communication preparation (COM PREP) signal at process block 401. This communication preparation signal is a signal generated at or before the time that a communication is to be sent by the master/pulser unit 108 to a zone control unit 105 to, for example, open a valve associated with the zone control unit. An example of a signal which may be used as a communication preparation signal comprises a signal that is generated by microcontroller 301 at some point in time before a time scheduled for opening a valve associated with one of the zone control units 105 to facilitate irrigation in the respective zone. In this example, microcontroller 301 may be programmed according to the invention generate a communication preparation signal at a given time, perhaps a few thirty seconds, prior to the scheduled date and time. The communication preparation signal may also be generated concurrently with a scheduled operating time for a given zone control unit 105.

Regardless of the specific nature of the communication preparation signal or under what circumstances it is generated by microcontroller 301, the illustrated example process according to the invention responds to that signal by applying a control signal to the supply signal circuit 316 as indicated at process block 402 in FIG. 4. In the example control unit 214 shown in FIG. 3, the supply control signal my represent simply a digital level signal to supply signal circuit 316 which in turn applies a supply operating signal to supply output terminal 306. This supply operating signal is applied over control line 216 to supply valve 205 to open the valve. Opening supply valve 205 allows water from supply conduit 110 to flow into main distribution conduit 102 which may have at least partially drained in the time since one of the zone control units 105 was last operated.

Once supply valve 205 has been opened in response to the signal applied as indicated at process block 402, the process includes checking for a communication condition (“COM CONDITION”) in the network 100 of irrigation conduits. This inquiry is shown at process block 404 in FIG. 4. As indicated by decision box 405, if the communication condition has not yet been met the process loops again preferably through suitable delay to check for the condition again. However, if the condition has been met, the process moves on to generate a communication release (COM RELEASE) signal as shown at process block 406. This communication release signal may be used within microcontroller 301 to set a condition in which the microcontroller can proceed to cause appropriate driving signals to be sent to drive pulser valve 210 to create pressure pulses in the irrigation water which may be picked up an interpreted by the zone control units 105 to activate a zone as desired. For example, a communication release signal may be used in microcontroller 301 to set a bit at a designated memory location, and the microcontroller 301 may be programmed to initiate a communication attempt to a zone control unit according to a predefined schedule only if the bit is set at that memory location. In this example, the memory location may be cleared once the communication to the zone control unit is successful, and the process may then await the next communication preparation signal.

As noted above, the communication condition may be defined as a certain amount of time which has elapsed since the supply valve is opened (at process block 402). In this case the inquiry at 404 in FIG. 4 may comprise reading a timer which was triggered when the supply control signal was applied at process block 402. Where the communication condition is defined as a parameter obtained from a sensor such as sensor 206, the inquiry at 404 in FIG. 4 may comprise saving a current value from the sensor (indicative of flow rate or pressure for example), and then comparing that current value with a stored trigger value which is indicative of the conduits in the irrigation system being full. If the current value bears a specified relationship to the stored trigger value, that state may be taken as meeting the communication condition.

The process shown in FIG. 4 results in an intervention in the pressure-pulse communication system to ensure the system is ready for such a communication. Rather than attempting a communication strictly according to scheduled time in an irrigation program executed by microcontroller 301, a time when the irrigation conduits may or may not be full, the process causes the supply valve to be opened until a designated communication condition is met. As described above in relation to the apparatus, this condition may be defined by the passage of time or by a parameter in the network of conduits such as flow rate or pressure. In any event, the intervention to check for the communication condition helps ensure the irrigation conduits are full and in condition to allow the pressure pulse-base signals to be transmitted through the irrigation water.

As used herein, whether in the above description or the following claims, the terms “comprising,” “including,” “carrying,” “having,” “containing,” “involving,” and the like are to be understood to be open-ended, that is, to mean including but not limited to. Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements which does not have the defined characteristic or feature.

The above described preferred embodiments are intended to illustrate the principles of the invention, but not to limit the scope of the invention. Various other embodiments and modifications to these preferred embodiments may be made by those skilled in the art without departing from the scope of the present invention.

1. A control apparatus for an irrigation system which includes a network of irrigation conduits and one or more zone valves which are operable in response to signals communicated through irrigation water in the network of irrigation conduits, the control apparatus including:
(a) a communication output terminal;
(b) a supply output terminal;
(c) a communication signal circuit operable to apply a communication drive signal to the communication output terminal in response to a communication control signal;
(d) a supply signal circuit operable to apply a supply operating signal to the supply output terminal in response to a supply control signal; and
(e) a controller operable to direct the supply control signal to the supply signal circuit at a first point in time and then direct the communication control signal to the communication signal circuit after a communication condition is met in the network of irrigation conduits after the first point in time.

2. The control apparatus of claim 1 wherein the communication condition comprises a predetermined amount of time after the first point in time.

3. The control apparatus of claim 1 further including a sensor input terminal connected to a sensor input of the controller, and wherein the controller is operable to determine whether the communication condition is met based on a sensor input signal received at the sensor input.

4. The control apparatus of claim 3 wherein the communication condition comprises a predetermined flow rate and the sensor input signal is indicative of flowrate into the network of irrigation conduits.

5. The control apparatus of claim 3 wherein the communication condition comprises a predetermined pressure and the sensor input signal is indicative of pressure in the network of irrigation conduits.

6. A method for controlling an irrigation system which includes one or more irrigation conduits and one or more zone valves which are operable in response to signals communicated through irrigation water in the one or more irrigation conduits, the method including:
(a) receiving a communication preparation signal;
(b) generating a supply control signal;
(c) applying a supply operating signal to supply output terminal in response to the supply control signal, the supply output terminal being adapted to be operatively connected to an electrically operated supply valve;
(d) determining if a communication-ready condition is present in the one or more irrigation conduits, and in response to the communication-ready condition, generating a communication control signal; and
(e) applying a communication release signal to enable communications to an electrically operated pulser valve in the irrigation system.

7. The method of claim 6 further including receiving a sensor input value and wherein determining if the communication-ready condition is present in the one or more irrigation conduits includes comparing the sensor input value to a predetermined value.

8. The method of claim 6 wherein the sensor input value is indicative of flow rate into the one or more irrigation conduits.

9. The method of claim 6 wherein the sensor input value is indicative of pressure in the one or more irrigation conduits.

10. The method of claim 6 wherein the communication-ready condition comprises a predetermined amount of time after applying the supply operating signal.

11. A master/pulser apparatus for an irrigation system which includes a network of one or more irrigation conduits and one or more zone valves which are operable in response to signals communicated through irrigation water in the one or more irrigation conduits, the master/pulser apparatus including:
(a) a flow path having a supply end adapted to receive irrigation from a supply conduit and having a distribution end adapted to be connected to the network of one or more irrigation conduits;
(b) an electrically operated supply valve operatively connected in the flow path;
(c) a branch conduit operatively connected in the flow path between the supply valve and the distribution end;
(d) an electrically operated pulser valve operatively connected in the branch conduit and operable to selectively open a distal end of the branch conduit to the atmosphere;
(e) a network condition sensor operatively connected in the flow path between the supply valve and the distribution end; and
(f) a control unit including:
(i) communication output terminal;
(ii) a supply output terminal;
(iii) a communication signal circuit operable to apply a communication drive signal to the communication output terminal in response to a communication control signal;
(iv) a supply signal circuit operable to apply a supply operating signal to the supply output terminal in response to a supply control signal; and
(v) a controller operable to direct the supply control signal to the supply signal circuit at a first point in time and then direct the communication control signal to the communication signal circuit when a communication condition is met in the network of one or more irrigation conduits after the first point in time.

12. The master/pulser apparatus of claim 11 wherein the communication condition comprises a predetermined amount of time after the first point in time.

13. The master/pulser apparatus of claim 11 further including a sensor input terminal connected to a sensor input of the controller, and wherein the controller is operable to determine whether the communication condition is met based on a sensor input signal received at the sensor input.

14. The master/pulser apparatus of claim 13 wherein the communication condition comprises a predetermined flow rate and the sensor input signal is indicative of flow rate into the network of one or more irrigation conduits.

15. The master/pulser apparatus of claim 13 wherein the communication condition comprises a predetermined pressure and the sensor input signal is indicative of pressure in the network of one or more irrigation conduits.
